(19) United States
(12) Patent Application Publication
(10) Pub. No.: US 2003/0159598 A1
(43) Pub. Date: Aug. 28, 2003

(54) Water powered washing and rinsing device

(76) Inventors: Michael Dutka, Daylestown, PA (US); William Bevacqua, Califon, NJ (US); Anne M. Troop, Metuchen, NJ (US); Elissa Sue Hoeger, Princeton, NJ (US); Christopher Ray Riley, Scotts Plains, NJ (US); Philip Salkie, Metuchen, NJ (US)

Correspondence Address: David Peter Alan, Esq., 81 Second St., South Orange, NJ, 07079, US

(21) Appl. No.: 10/032,426

(22) Filed: Dec. 31, 2001

(51) Int. Cl. A23B 4/08; A23B 4/12

(52) U.S. Cl. 99/536; 99/516

(57) ABSTRACT

A device is disclosed for washing or rinsing food or nonfood items or objects powered by a water source, such as a kitchen faucet or other continuously-running or intermittent source. A pot-shaped chamber at the center of the device, in combination with a smaller pot-shaped chamber, frontwardly and upwardly mounted to said pot shaped chamber at the center, form the vessel for holding water and the items to be washed. This smaller chamber is counterbalanced by a weighted handle to the rear of the vessel. The vessel is, in turn, mounted on a stand that allows it to pivot about its center of gravity. Water from the water source enters the vessel and washes the items inside. When sufficient water has flowed into the smaller chamber of the vessel to place more weight to the front of the center of gravity than the handle provides behind it, the vessel tips forward, spilling out the water that had been inside it. With no water in the vessel, the weighted handle then counterbalances the vessel, causing it to pivot back into its initial position on its stand. A mesh screen secured to the top of the vessel keeps the items to be washed from escaping during the process. Water from the water source then refills the vessel for another interation of the washing operation. Washing continues until the operator turns off the water source and empties the vessel manually.

### BACKGROUND OF THE INVENTION

Some foods require a great deal of washing or rinsing before they can be eaten or prepared for consumption. For example, in some cuisines, rice must be washed extensively before cooking to remove the gluten, so the rice will not stick together in clumps when cooked. It is also customary to wash or rinse other foods, ranging from beans to fresh fruit. Even some cooked foods, such as pasta, are rinsed before they are eaten or stored to be eaten at a future time.

There have been specialized devices available for washing or rinsing specific foods, such as rice. For example, Fakuda, U.S. Pat. No. 5,156,082 (1992) teaches a complex electrical appliance with sophisticated control means to rinse and cook rice, and then to keep it warm. Horton, U.S. Pat. No. 4,756,323 (1998) teaches a device for rinsing rice with two chambers; one for the rice and the other for the water used to rinse the rice. The Horton device is simple to operate, but it requires the operator's attention and activity at all times during the rinsing operation. It is also specifically designed for the preparation of rice, and its claims are specifically drawn to the rinsing of rice.

Accordingly, it is an objective of the present invention to allow the washing or rinsing of other food items, in addition to rice. In the practice of the present invention, nonfood items, such as precious stones and other small objects can be washed in the same manner as food items requiring washing or rinsing.

It is a further objective of the present invention to allow the washing or rinsing process to continue without the requirement that the operator devote continuous attention and activity to that task. In short, the invention described here allows the operator to begin the washing or rinsing process, leave the device and attend to another task while washing or rinsing continues, and intervene again only to terminate the washing or rinsing process when sufficient washing or rinsing has occurred.

It is another objective of the invention to utilize a continuous or intermittent water source for the washing or rinsing operation, and to have that source of water also provide power for the device, thereby eliminating the need to provide manual, electrical or other effort to accomplish the washing or rinsing operation.

Note that a continuous water source is preferred but not essential to the device's operation, and that the device would work effectively when filled and refilled from a non-continuous source, such as a bottle of water. Note as well that in some instances, it may be necessary or desirable to use other liquids than water in the operation of the device, such as broth in the washing of food items, and cleaning solutions in the washing of food and other nonfood items and objects.

### BRIEF DESCRIPTION OF THE INVENTION

The invention described here begins with a specially designed and constructed vessel, where the washing or rinsing operation occurs. The main chamber of the vessel, which is shaped like a pot in the preferred embodiment of the invention, has a frontwardly and upwardly mounted front chamber that is not as deep as the main chamber of the vessel, and that is mounted such that the top edge of the front chamber is at the same height as the top edge of the main chamber of the vessel. In the practice of the invention, the vessel, including front chamber, will fill with water and eventually tip over, spilling the water that had been in the vessel.

A handle, located behind the main chamber of the vessel and attached in two places near the top and the bottom of the main chamber of the vessel respectively, is sufficiently heavy to counterbalance the front chamber until a sufficient amount of water is placed therein. A special stand holds the vessel in place under a faucet or other source of water for washing. The stand holds the vessel in place, and a strategically-placed stopper, which forms part of the stand, supports the rear of the main chamber of the vessel. This stopper prevents the vessel from tipping backward at any time during operation, and also keeps it horizontal, both when it is empty and while its is in the process of being filled. The stand also allows rotation of the vessel along a forward and downward arc (clockwise, if the front of the vessel is facing toward the right).

The same strategically-placed stopper prevents rotation beyond the point required for spilling out the water that had been in the vessel, approximately seventy to seventy-five degrees from the horizontal. When the vessel is empty and the counterbalancing weight of the handle causes the vessel to pivot backwards, the same stopper then once more supports the rear of the main chamber of the vessel, allowing the vessel to return to, but not pivot past its original horizontal attitude. A mesh screen secured to the top of the vessel keeps the items to be washed from escaping during the process.

Looking briefly at the operation of the invention, the operator places into the vessel the items to be washed, such as rice to be prepared for cooking. The operator then places the mesh screen over the top of the vessel to prevent the items from escaping during washing. Next, the operator places the stand in the sink and places the vessel assembly on the stand, so that pivot pins in the stand engage recessed channels on the sides of the vessel to allow rotation. As part of vessel placement, the vessel should be located under the water faucet in the sink. The operator then turns on the faucet which, in turn, begins to fill the vessel with water.

When the vessel is sufficiently full, the water in the front chamber of the vessel becomes heavier than the handle at the rear of the vessel. At that time, the weight of the water in the front chamber causes the vessel to rotate forward and downward on the stand, thereby causing the water to spill out.

When the water has left the vessel and spilled into the sink and down the drain, the rear of the vessel is again heavier than the front, due to the weighted handle at the rear. The previous rotation is then reversed. The vessel returns to its original horizontal attitude, where it is ready to accept new water from the faucet. The vessel begins to fill again with fresh water, and a new iteration has begun. The process continues until the operator terminates it by turning off the water, manually pouring out any water remaining in the vessel and removing the items that have just been washed.

### BRIEF DESCRIPTION OF THE DRAWINGS

FIG. 1 shows a side view of the washing device in its stand.

FIG. 2 is a rear view of the stand for the vessel assembly. The vessel assembly is not depicted.

FIG. 3 is a top view of the screen unit that covers the vessel in the operation of the preferred embodiment of the invention.

FIG. 4 shows a detail of the recessed channel which mounts to the side of the vessel, and which engages pins in the stand, allowing the vessel to rotate on the stand in operation.

FIG. 5 shows an alternate embodiment of the invention, in which a spring is used to limit rotation of the vessel and to return the vessel to its original position.

FIG. 6 refers to the embodiment depicted in FIG., showing only the stand, from a rear diagonal view.

FIG. 7 shows an alternate embodiment of the invention in which cradle-like support members are located on the stand to receive pins attached to the vessel.

FIG. 8 shows an alternate shape of the vessel.

### DETAILED DESCRIPTION OF THE INVENTION.

The preferred embodiment of the invention described begins with a specially-designed vessel for washing food or nonfood items. Main vessel chamber 10 is joined to front extension chamber 11, to form one single vessel to receive the objects to be washed, as well as the water for washing.

Front extension chamber 11 is fixedly mounted to main chamber 10, and there is no wall between them. Front extension chamber 11 is joined to the upper portion of main chamber 10, such that the top edge of main chamber 10 is at the same height as the top edge of front extension chamber 11. Main chamber 10 and front extension chamber 11 join to form a single vessel.

In the prototype for the invention described, main chamber 10 is a three-quart aluminum pot and front extension chamber 11 is a two-quart aluminum pot. Other sizes of pots, to create other sizes of chambers, can also be used in accordance with the principle of this invention. Both chambers are welded together, and any metal that stood as a barrier between main chamber 10 and front extension chamber 11 is removed, permitting the free flow of water between the two chambers. Alternatively, the barrier between main chamber 10 and front extension chamber 11 may be perforated with holes, or an aperture may be cut into it, and screening material placed contiguously with, to cover, the perforation or aperture. This screening material will retain the items to be washed in main chamber 10, but still permit the free flow of water between the two chambers. In this instance, the items to be washed will only be placed in main chamber 10, and the screen will only cover main chamber 10. When the vessel consisting of main chamber 10 and front extension chamber 11 is filled with a sufficient amount of water, the weight of the water shifts the center of gravity forward from its location when the vessel is empty.

Counterbalancing front extension chamber 11 is handle 12, which is located to the rear of main chamber 10. In the prototype of the invention described, handle 12 is weighted with a twelve-ounce weight. In the practice of the invention, handle 12 must be sufficiently weighted to rotate the entire vessel back to horizontal position when the water that had been inside the vessel has spilled out, but light enough to allow the vessel to tip forward and cause the water inside to spill out after sufficient water has accumulated inside the vessel. When the water has spilled out of the vessel until it is empty or nearly empty, the weight of handle 12 again brings the center of gravity rearward.

FIG. 1 also shows the stand upon which the vessel rests. While only one side of the stand is visible in FIG. 1, the stand is actually symmetrical, and the view from the other side of the device would appear to be a mirror image of FIG. 1. The stand can be made from solid or hollow metal or plastic tubing, or from metal pieces bolted or otherwise held together to form the configuration described here. In the prototype of the invention, several solid metal rods were bent and welded together to form the appropriate configuration. It is essential that the stand be sufficiently strong and properly balanced to support the vessel when it is placed on the stand and filled with water, and that the front extension of the stand be heavy enough to keep the vessel and the stand from tipping backward during the rear rotation portion of the washing cycle.

The structure of the stand is as follows, as seen from the side, as in FIG. 1: A front member 13 and its counterpart on the (other side of the stand, 13′, are sufficiently long to stabilize the entire unit when placed in a sink or other place of operation. Cross-piece 18, connecting the two horizontally-oriented front members 13 and 13′, is weighted such that it is heavy enough to keep the vessel and the stand from tipping backward during the rear rotation portion of the washing cycle.

Two reciprocally diagonally-oriented members 14 and 15 form two sides of a triangle, with the stand contacting the vessel at the triangle's apex. Identical members 14′ and 15′ form another triangle on the other side of the stand, with the vessel also contacting this other triangle at this other triangle's apex.

The vessel pivots at these two apical points (denoted point C for Centerpoint, in FIG. 1, and its opposite, C', on the other side of the vessel), as has been described.

The rear portion of the stand can be better seen from FIG. 2, which shows it without the vessel unit. The bottom points of members 15 and 15′ are located at the rearmost part of the stand, and are connected to rear horizontal members 21 and 21′, which extend rearward from diagonal members 15 and 15′, to a point directly below and toward the rear of the vessel, when it is horizontally oriented. Two reciprocally diagonally-oriented members 16 and 16′ rise from rear horizontal members 21 and 21′ to form two sides of a third triangle at the back of the stand in the same way as members 14 and 15, as well as 14′ and 15′ form triangles along the sides of the stand. At the apex of said third triangle formed by member 16 and 16′ and at the center of the space between members 21 and 21′, sits stopper 17. Stopper 17 can be made out of cork, rubber, plastic or any suitable material capable of contacting main vessel chamber 10 without causing it damage. Stopper 17 may be in the shape of a truncated pyramid, a truncated cone, a rectangular solid, or any other shape that will bump against the bottom surface of the vessel, both when it is at a horizontal attitude, and when it rotates forward during the washing cycle. In the prototype of the invention, stopper 17 is a truncated pyramid made of hard rubber and forced onto the apex of the triangle containing members 16 and 16′. A screw, rivet or other means of holding stopper 17 in place is also acceptable.

Main vessel chamber 10 is engaged by pivot pins 20 and 20′, located at the apices of the triangles formed by the two diagonal members 14 and 15 on one side, and by the two diagonal members 14′ and 15′ on the other. Pins 20 and 20′ are sufficiently long to nearly contact main vessel chamber 10 at its diameter, but they still allow sufficient clearance for the vessel to allow it to pivot on pins 20 and 20′ when two extensions providing recessed channels to engage pins 20 and 20′ are mounted on main vessel chamber 10. Pins 22 and 22′ attached to the apices of the triangles formed by members 14 and 15, and 14′ and 15′ prevent the vessel from being removed from the stand by the force of the backward rotation when the water spills out of the vessel and the weighted handle returns the vessel to its horizontal position on the stand.

FIG. 3 shows a top view of the vessel unit, without the stand. FIG. 3 shows a sieve unit, removably mounted on top of the vessel and covering it. Mesh screen 30 is fixedly mounted to border 31, which fits on top of the vessel, and is positioned there by hooking clip members, clips 32. Mesh screen 30 may be made of plastic, stainless steel, aluminum or any other material that does not rust and does not interact with food items that might be washed inside. The sort of screening used for food strainers in kitchens is suitable. Screen 30 and border 31 may be secured to the vessel by any means known in the art.

In the prototype of the invention, a plurality of short vertical members extend upward from border 31, and terminate in clips 32 (six such clips are depicted here, although fewer are sufficient in practice), which fit over the outer rim of the vessel.

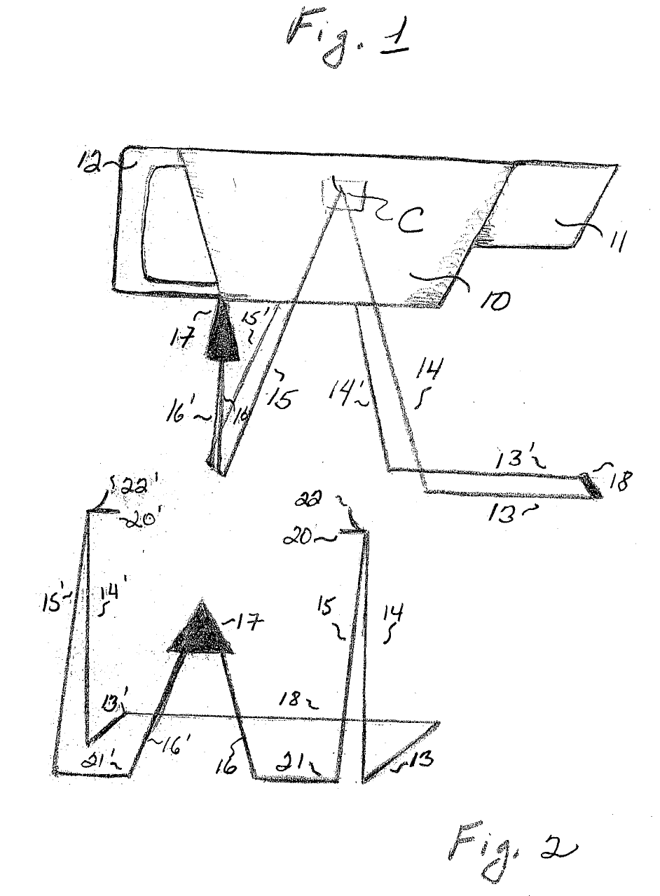

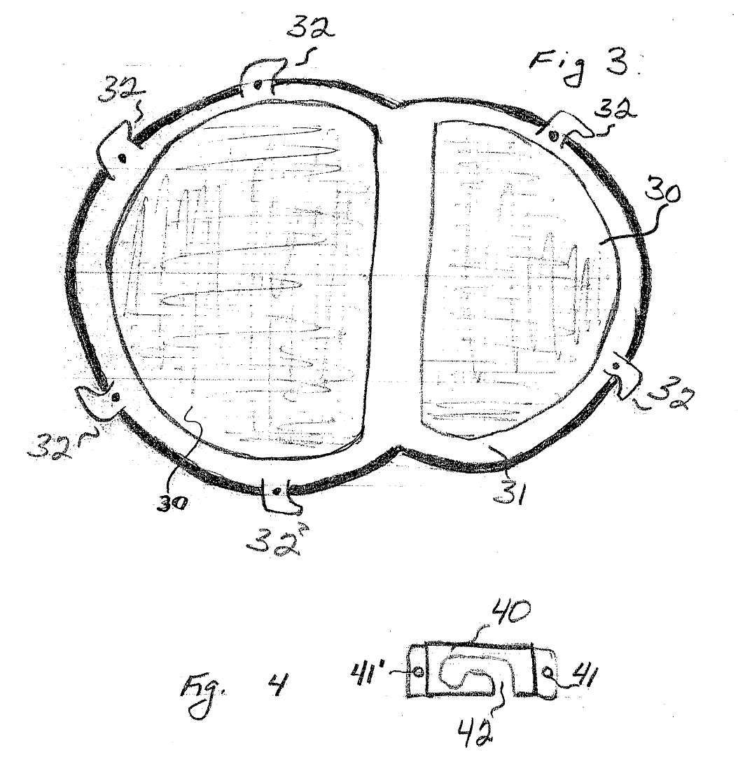

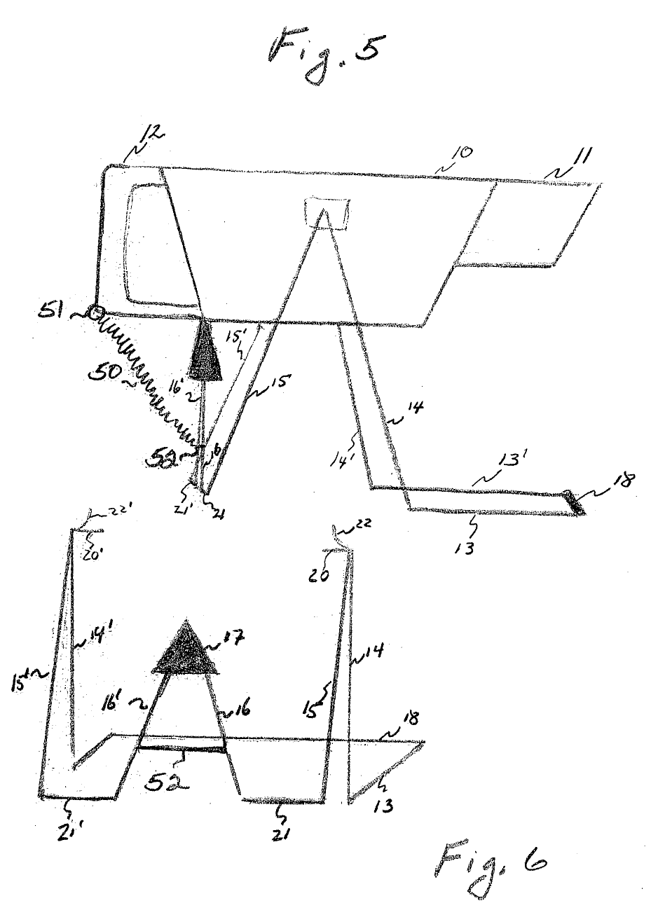

FIG. 4 shows a bracket for receiving pivot pins 20 and 20′, which form part of the stand unit. Two such brackets are used, located on opposite sides of main vessel chamber 10, and with their central portions extending outward slightly from main vessel chamber 10. The brackets are mirror images of each other. Looking at one of the brackets, bracket 40 extends outwardly (toward the viewer, if the surface of the vessel at the diameter approximates the plane of the drawing sheet) in its central portion. Side portions lie flush with the surfaces of the vessel and are held onto the vessel by rivets 41 and 41′. Bracket 40 can also be bolted onto the vessel, or more than one rivet may be used on each side. Cut out from the central portion of bracket 40 is recessed channel 42, which engages pivot pin 20. Recessed channel 42 has a vertical component at the front, and is also curved rearward and eventually downward, terminating in a small keyway toward the rear of the central portion of bracket 40. When the vessel is oriented horizontally for filling with water, pivot pin 20 engages the vertical and frontward portion of recessed channel 42. When the vessel is in position for spilling water, pivot pin 20 or 20′ engage bracket 40 and at its rearmost point of termination. The bracket on the other side of the vessel, hidden bracket 40′, is the mirror image of bracket 40, and engages unseen pivot pin 20′. In the prototype of the invention, the center of bracket 40 and its counterpart on the other side of the vessel are located on opposite sides of the vessel's main chamber 10, at or near where main chamber 10 is widest, two inches below the rim. Vertically, bracket 40 and its counterpart on the other side of the vessel should be located at a height above the floor of front extension 11, such that sufficient water entering main chamber 10 and front extension 11 will cause a greater weight of water to be placed forward of the axial diameter of main chamber 10, thereby causing the vessel to rotate with front extension 11 moving forwardly and downwardly (clockwise as viewed in FIGS. 1 and 3), thereby in turn causing the water contained therein to spill out.

For the purposes of the description, the operation of the invention is described using water as the liquid for washing and rinsing purposes. The inventors have envisioned that water will be used in the practice of the invention, and its operation is described this way. However, this invention can be used with other liquids, such as broth or food cleaners for food products, and organic and other solvents for cleaning non-food items. Another substance dissolved in water, or in some other liquid can be used in the practice of the invention, such as soap for cleaning non-food items.

The invention operates as follows, as envisioned by the inventors. The operator places into the main chamber of the vessel the items to be washed, such as rice to be prepared for cooking. The operator then places the sieve unit consisting of screen 30, border 31 and clips 32 onto the rim of the vessel above the objects to be washed. The operator then places the stand unit in the kitchen sink and positions the vessel unit on top of the stand, with pins 20 and 20′ engaging bracket 40 and its counterpart on the other side of the vessel to allow rotation. As part of vessel placement, in its most common utilization, the vessel will be located in a sink, under the water faucet (not pictured in the drawings).

At this time, the vessel contains only the objects to be washed, and a portion of the rear edge of the vessel rests on the top surface of stopper 17.

The operator then turns on the faucet which, in turn, begins to fill the vessel with water, thus beginning the washing operation.

As water accumulates in the vessel, the water level will eventually reach the floor of front extension chamber 11, and it will begin to fill, while main chamber 10 continues to fill. When, in this filling process, there will be sufficient water in front extension chamber 11 that there will be more weight forward of pivot pins 20 and 20′ than rearward of pivot pins 20 and 20′, the weight of the water inside will push front extension chamber 11 and the water in it downward. Rotational motion then proceeds through the engagement of pivot pins 20 and 20′ with recessed channel 42 and the counterpart to recessed channel 42 on the other side of the vessel.

Water then spills out from the vessel and through the sieve unit covering it, specifically the screen. This water, which has already come in contact with the objects to be washed, is emptied into the sink and down the drain. Rotation continues for approximately 70 to 75 degrees of arc, and must be sufficient to empty all or nearly all the water that had been in the vessel.

To stop rotation, the bottom of the vessel bumps into stopper 17 and proceeds no further. The items to be washed are held inside the vessel throughout by the sieve unit consisting of mesh screen 30, border 31 and clips 32.

After the water is evacuated from the vessel, the rear portion thereof is heavier than the front portion, due to the weight of handle 12. Gravity pulls the rear portion of the vessel downward, and it rotates back to the horizontal position, again with pivot pins 20 and 20′ engaging recessed channel 42 and its counterpart on the other side of the vessel. The bottom surface of the vessel then comes in contact with the top surface of stopper 17 when the vessel is in a horizontal position, and water again begins to fill the vessel, thereby starting a new washing cycle.

This process is repeated continuously, with the only external power being the running water from the faucet in the sink, or whatever water source is used. No attention from the operator is required during the washing operation. Moreover, fresh water is applied during each washing cycle. When the operator believes that the food or other items to be washed are sufficiently clean, he or she terminates the washing operation by turning off the water, picking up the vessel unit by handle 12 and spilling out any accumulated water manually.

At this point, the operator has the choice of either removing the items which have been washed from the vessel or, alternatively, of pouring fresh water into the vessel and using the vessel as a pot for cooking the food that had just been washed, provided, of course, the vessel, as the prototype, is made of a metal, ceramic or other material capable of withstanding the heat of cooking.

Although the preferred embodiment of the invention has been described, other embodiments are possible. Attaching Handle 12 only to the top, or even only to the bottom of the main chamber of the vessel will serve the same counterbalancing function, as will attaching Handle 12 in more than two places, and also attaching it to the main chamber of the vessel contiguously, along its entire length. Handle 12 is replaceable with a weight at the lower rear portion of the vessel, which will also provide weight to restore the vessel to horizontal position after accumulated water had spilled from it. Alternatively, a spring mounted to the vessel and to the stand, used instead of, or in conjunction with the weighted handle or other weighted member will also restore horizontal orientation. This can be seen in FIG. 5. Spring 50 is connected at one end to ring 51, which is fixedly mounted to the rear of the vessel. At its other end, spring 50 is attached to the center of cross-bar 52, which is horizontally oriented and connects diagonal members 16 and 16′. Spring 50 is in its compressed position while the vessel is horizontally oriented, and is stretched when the vessel is filled with liquid.

In an alternate embodiment, instead of the pivot pins being fixedly mounted to the stand and rotating within recessed channels fixedly mounted to the vessel, pivot pins are fixedly mountable to the vessel for insertion into circular opening at the apical points on the stand mentioned previously. In such operation, said apical points on the stand are capable of being spread apart slightly to receive the pivot pins for operation.

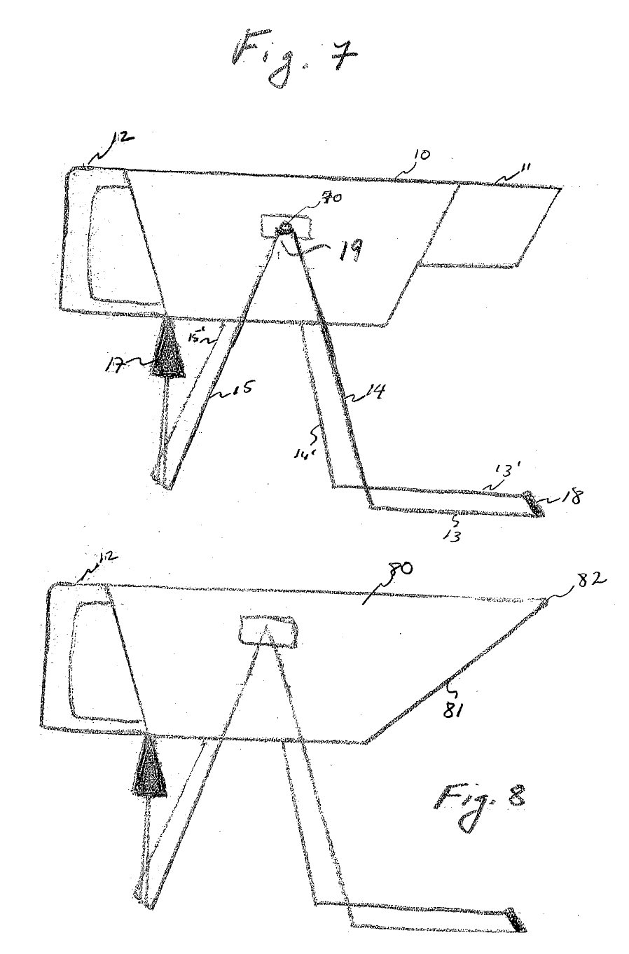

Alternatively, as shown in FIG. 7, support member 19 is curved with a cradle-like shape, and allows rotation of pivot pin 70, attached to the vessel, thereupon. A similar pivot pin 70′ (not depicted) extends from other side of the vessel, resting on the other support member 19′ (not depicted), which is located at the apex of the triangle on the other side of the stand.

As shown in FIG. 8, the shape of main chamber 10 and front extension 11 is replaceable with tapered vessel 80, with a diagonally sloping front 81 and spout 82 at the front and top thereof for spilling accumulated water into the sink when sufficient water had entered the washing chamber to tip it frontwardly. The invention described need not be used in a sink, but will also function in other situations, such as outdoors, by filling the vessel with water from bottles, cups, or from a hose, and allowing water to spill onto the ground.

In an alternative design of the sieve unit, a screen between main vessel chamber 10 and front extension 11, will keep the objects to be washed contained in main vessel chamber 10. In that embodiment, mesh screen 30 and border 31 will fit only over main vessel chamber 10, and not over front extension 11.

Bracket 40 and its counterpart on the other side of the vessel may be placed slightly forward, or slightly to the rear of, the diameter of main vessel chamber 10, to allow for more or less weight in handle 12. Instead of stopper 17, two stoppers can be employed; one to support the bottom of the vessel in horizontal orientation, and the other to prevent rotation during emptying past the desired angle for emptying. In the preferred embodiment of the invention, members exhibiting a triangular shape, with pivot points at their apices, were disclosed. Alternatively, an arched or rectangular shape, or any other shape that allows for pivot pins to be located at the appropriate height is also acceptable.

The vessel described can be of any functional size, and made out of any material acceptable for holding food items or other objects to be washed. Metal and plastic are acceptable materials, although glass and ceramic may also be used. None of these alternate embodiments changes the basic principle of a water-powered washing or rinsing device that operates continuously without operator intervention. The embodiments herein described should be considered illustrative and not limiting. Other embodiments are possible, and they should be thought of as lying within the scope of the invention.

The invention claimed is:

1. A device for washing or rinsing foodstuffs or nonfood items powered by the filling of said device with water or any other liquid used in the process of such washing or rinsing, comprising: a vessel in which said washing or rinsing takes place; a means for emptying said vessel of liquid after it has washed or rinsed said foodstuffs or nonfood items and allowing refilling of said vessel, such means operating periodically and cyclically without attention from any person during said rinsing or washing operation; and a means for keeping the foodstuffs or nonfood items washed or rinsed inside said vessel during said wishing or rinsing operation.

2. The device as in claim 1, in which the liquid used for said washing or rinsing operation is water.

3. The device as in claim 2, in which said water is provided by a continuously running source.

4. The device as in claim 1, in which said vessel further comprises a central chamber capable of holding the foodstuffs or nonfood items to be washed or rinsed, along with a front extension chambers contiguous therewith and with no barrier between said central chamber and said front extension chamber, said front extension chamber placed frontward from, and with its bottom higher than that of said central chamber, with the result that the center of gravity of said vessel will be shifted forward from the horizontal center of said central chamber when said front extension chamber of said vessel is filled with a sufficient amount of liquid.

5. The device as in claim 4, in which said vessel comprises two chambers, said central chamber being the larger of such chambers, said front extension being the smaller of such chambers, and such chambers being contiguous with each other and with no barrier between their inside surfaces.

6. The device as in claim 5, further comprising a screen that mounts over the vessel.

7. The device as in claim 1, in which said vessel is of a shape, tapered in width from its widest near its rearmost point or line, to its narrowest at its forwardmost point, with such forwardmost point culminating in a spout, and said tapering of the shape of said vessel occurring also from maximum depth at the rear part of said vessel, to minimum depth at the forwardmost point of said vessel, said forwardmost point also being situated at or near the top surface of said vessel.

8. The device as in claim 7, further comprising a screen that mounts over the vessel.

9. The device as in claim 1, further comprising a stand for said device, which holds said device in position for operation.

10. The device as in claim 9, in which said stand further comprises a means for holding said vessel in a horizontal position for the reception of liquid for use in said washing or rinsing operation.

11. The device as in claim 10, in which said means is a stopper fixedly mounted to said stand and positioned at a height sufficient to contact the bottom surface of said vessel, such that said vessel is oriented in the horizontal plane when the rear portion of its bottom surface is in contact with said stepper.

12. The device as in claim 9, in which said stand further comprises a means for contacting said vessel that allows rotational motion of said vessel.

13. The device as in claim 12, further comprising a means for cessation of rotational motion when the liquid that had previously been in the vessel has been emptied therefrom.

14. The device as in claim 13, in which said means is the stopper mentioned in claim 11, so positioned as to engage said vessel when sufficient rotational motion to empty said liquid from said vessel has been completed.

15. The device as in claim 13, in which said means comprises a second stopper, in addition to the stopper mentioned in claim 11, said second stopper being so positioned as to engage said vessel when sufficient rotational motion to empty said liquid from said vessel has been completed.

16. The device as in claim 3, in which the means for continuously filling said vessel with water is the running of water from the faucet on a sink.

17. The device as in claim 1, in which the means for emptying said vessel of liquid utilizes the rotational motion of said vessel with respect to said stand in one rotational direction when said vessel has received sufficient liquid to move the center of gravity forwardly from the position it would occupy if said vessel were empty, and the weight of said liquid causes such rotational motion, and the rotational motion in the opposite rotation direction after the rotational motion caused by said temporary movement of the center of gravity of said vessel has caused the liquid therein to spill and be thereby removed from said vessel.

18. The device as in claim 17, further comprising a means for quickly restoring said vessel to a horizontal position to accommodate the reception of a new quantity of liquid for further washing or rinsing.

19. The device as in claim 18, in which said means comprises a spring stretchably attached to said vessel upon the rear surface of said vessel, as well as to the stand upon which said vessel sits, said spring stretching when said vessel rotates to empty accumulated liquid, and returning to its compressed state when said liquid has been emptied from said vessel; said compression of said spring effecting the return of said vessel to a horizontal orientation.

20. The device as in claim 18, in which said means for restoring said vessel to a horizontal position comprises a weighted member located rearward from the center of gravity of said vessel.

21. The device as in claim 20, in which said weighted member is a handle.

22. The device as in claim 21, in which said weighted member is a weight placed inside said vessel, upon the floor of said vessel and at its rearmost point.

23. The device as in claim 1, in which said means for keeping said foodstuffs or nonfood items inside said vessel during said washing or rinsing operation further comprises a screen through which liquids can pass, but solid items cannot.

24. The device as in claim 23, in which said screen is sufficiently large to cover the entire area of said vessel, parallel to the top and bottom of said vessel and at a predetermined height above the bottom surface of said vessel, or is sufficiently large to cover the portion of said vessel which is normally filled with liquid until the moment before the emptying of said liquid from said vessel occurs.

25. The device as in claim 23, in which said vessel is shaped according to the configuration mentioned in claim 5, further comprising a screen fixedly mounted between said central chamber and said extension chamber, said screen permitting liquids, but not solid items, to pass therethrough.

26. The device as in claim 25, in which the screen mentioned in claim 23 covers only the central chamber of said vessel, and not the extension chamber thereof.

27. The device as in claim 26, in which the device mentioned therein is removably attached to said vessel by means of a plurality of clips which engage the top surface of the central chamber of said vessel.

28. The device as in claim 24, in which said screen is removably attached to said vessel.

29. The device as in claim 28, in which said screen is removably attached to said vessel by means of a plurality of clips which engage said vessel.

30. The device as in claim 17, in which said rotational motion is actuated by means of pins fixedly mounted to said stand, located at a specific height and located a sufficient distance apart to leave a narrow space open when the diameter of said vessel is passed between said pins, said pins also engaging recessed channels fixedly mounted to said vessel at a specific height and on opposite sides of said vessel at the diameter thereof.

31. The device as in claim 30, in which said pins engage said channels to permit sufficient rotational motion to allow said vessel to be oriented up to seventy-five degrees from the horizontal plane when such rotational motion has been fully actuated.

32. The device as in claim 31, in which said recessed channels are located within brackets fixedly mounted to the sides of said vessel and extending outwardly therefrom.

33. The device as in claim 17, in which said rotational motion is actuated by means of pins fixedly mounted to said vessel and extending outwardly therefrom, said pins also being received by cradlelike support members fixedly mounted to said stand in such a manner as to permit rotational motion of said pins therewithin.

34. The device as in claim 33, in which said pins engage said cradlelike support members to permit sufficient rotational motion to allow said vessel to be oriented up to seventy-five degrees from the horizontal plane when such rotational motion has been fully actuated.

35. A device for washing or rinsing foodstuffs or other nonfood items, where the improvement consists of the ability to continuously wash or rise such items, with power for such washing or rinsing operation provided solely by the impartation of water of any other liquid used for said washing or rinsing operation, and with no intervention from the operator of such device during said washing or rinsing operation.
